(19) United States
(12) Patent Application Publication
(10) Pub. No.: US 2009/0009468 A1
(43) Pub. Date: Jan. 8, 2009

(54) MULTI-FUNCTIONAL WIRELESS MOUSE

(75) Inventors: JIAN-GUO ZHU, Shenzhen (CN); SHIH-FANG WONG, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Taipei Hsien (TW)

(21) Appl. No.: 11/773,411

(22) Filed: Jul. 4, 2007

(51) Int. Cl. G06F 3/033

(52) U.S. Cl. 345/158

(57) ABSTRACT

A multi-functional wireless mouse (1) includes a mouse body 2 and a circuit board 3. A scrolling wheel (11), a plurality of selection button (12), an earphone jack (13), a microphone (14), a speaker (15) and a laser led (16) are mounted on the mouse body 2. The circuit board 3 includes: a wireless module (30), an audio amplifying circuit (403) for amplifying an analog audio signal, an audio output unit (401) for outputting the amplified analog audio signal, and an audio input unit (402) for inputting an analog audio signal. The advantage of the present invention is that the multi-functional wireless mouse (1) can receives a wireless audio signal sent by a computer through a wireless transceiver module (301) and sends wireless audio signal to the computer, and wireless operates the computer. Additionally, the mouse (1) can be used as a pointer.

### BACKGROUND OF THE INVENTION

1. Field of the Invention

The present invention relates to wireless mice, and more particularly to a multi-functional wireless mouse capable of transmitting audio signal.

2. Description of Related Art

One of peripheral devices of a computer, is a mouse. Mice can be attached to a computer with a wire or can be wireless. A wired mouse connects with a computer by a data cable, which requires the user to sit near the computer because of the limitation of the data cable's length. A wireless mouse uses a wireless transceiver to connect the mouse to the computer, thereby eliminating the data cable between the mouse and the computer, however conventional wired and wireless mice cannot receive audio data from the computer, thus the user is unable to listen to music by the computer via the mouse.

The Unite States Patent Application Publication No. 20060109262, entitled “Structure Of Mouse Pen” discloses a wireless mouse configured with a wireless transmission module and a media player. The wireless mouse utilizes the wireless transmission module to transmit operational signals to a computer, thereby operating the computer, and utilizes the media player to play music files that is stored in the wireless mouse. The wireless mouse includes a storage unit to store music files. However, the wireless mouse provided by the Patent Application Publication No. 20060109262 has a limited storage capacity for storing the music files as compared with the computer.

### SUMMARY OF INVENTION

Therefore, it is necessary to provide a multi-functional wireless mouse, which can transmit wireless encoded audio signals between the wireless mouse and a computer, and operate a computer in the distance too. The multi-functional wireless mouse includes mouse body inside which a circuit board is mounted. A microphone, a laser led, a speaker, an earphone jack, a plurality of selection button and a scrolling wheel are mounted on the mouse body. The circuit board includes: a wireless transceiver module; an encoder/decoder module, a microprocessor comprising an A/D (analogy to digital) converter and a D/A (digital to analogy) converter; an audio amplifying circuit, an audio input and an audio output unit. The wireless module receives wireless audio signals from a computer and outputs the wireless audio signals to the encoder/decoder module. The encoder/decoder module decodes the wireless audio signals and outputs digital audio signals to the D/A converter. The D/A converter converts the digital audio signals to analog audio signals and outputs the analog audio signals to the audio amplifying circuit, the audio amplifying circuit amplifies the analog audio signal and transmits the amplified analog audio signal to the audio output unit to output. The audio input unit is used for receiving an analog audio signal, the analog audio signal is amplified through the audio amplifying circuit, then send the amplified analog audio signal to the A/D converter, and convert the amplified analog audio signal to a digital audio signal. The digital audio signal is encoded by the encoder/decoder module and transmitted to the computer through the wireless transceiver module. The multi-functional wireless mouse further includes a laser beam module can emit a laser beam through the led for pointing out the displaying document of a computer, and enhance the impression of the speech.

### BRIEF DESCRIPTION OF DRAWINGS

FIG. 1A shows a top perspective view of a multifunctional wireless mouse;

FIG. 1B shows a bottom view of multifunctional wireless mouse;

FIG. 2 shows a block diagram of the circuit board; and

FIG. 3 is similar to FIG. 2, but showing details of several modules of the circuit board of FIG. 2; and

FIG. 4 shows a flow chart of an audio communication between a computer and a multifunctional wireless mouse.

### DETAILED DESCRIPTION OF THE EMBODIMENTS

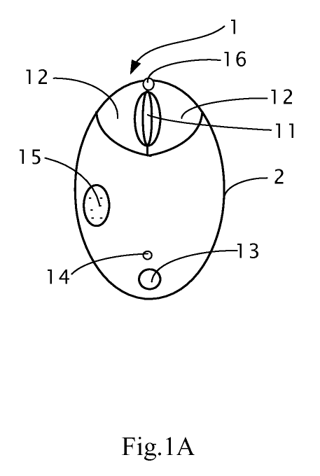

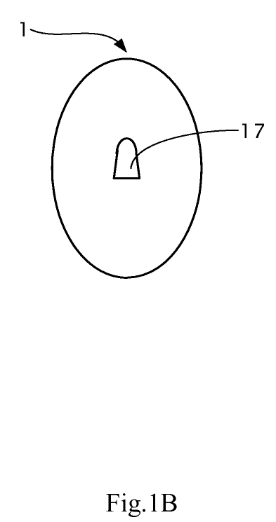

FIG. 1A and FIG. 1B shows a top perspective view and a bottom view of a multifunctional wireless mouse 1 (hereinafter “the mouse”), respectively. The mouse 1 comprises a mouse body 2. A scrolling wheel 11 and a plurality of selection button 12 is mounted on the top front end of the mouse body 2, a laser led 16 is also mounted in the front end of the mouse body 2, the laser led 16 for producing a laser beam. An earphone jack 13 and a microphone 14 are mounted on the other end of the mouse body 2, a speaker 15 is mounted on the top of the mouse body 2, a led 17 is mounted on the bottom of the mouse 1.

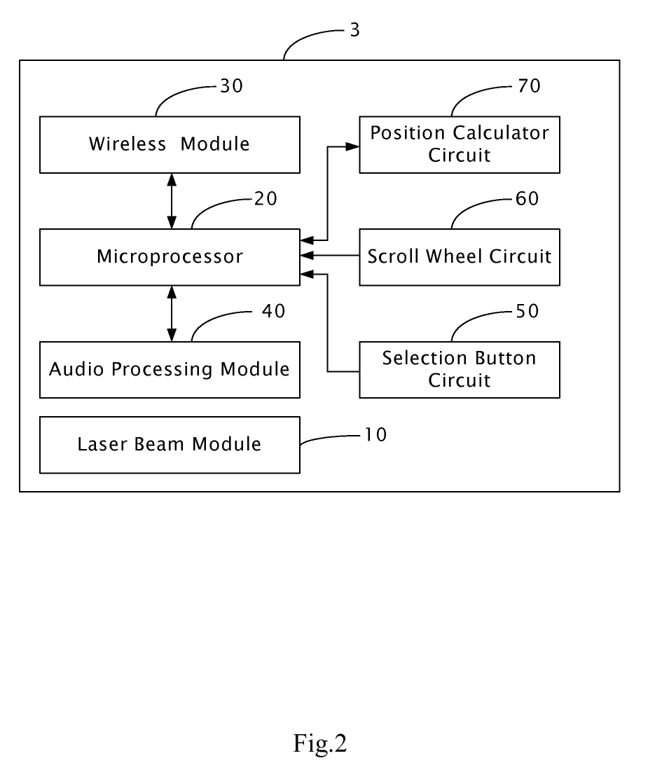

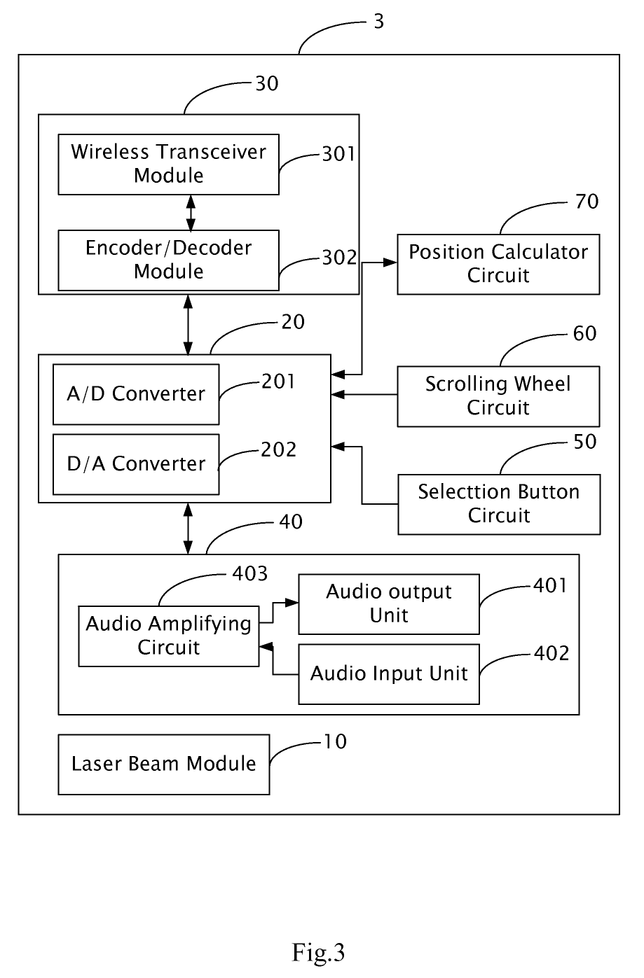

FIGS. 2 and 3 both show a block diagram of a circuit board 3 in accordance with a preferred embodiment of the present invention. The circuit board 3 is used for implementing the mouse function. The circuit board 3 includes a wireless module 30 such as a Bluetooth chip. The wireless module 30 includes a wireless transceiver 301 and an encoder/decoder module 302. Through the wireless module 30, the mouse 1 is able to transmit mouse operational signals to a computer (not shown) as well as performing audio communication with the computer.

The circuit board 3 further includes a selection button circuit 50, the selection button circuit 50 connect with the selection button 12 (see FIG. 1A) for outputting selection signals that perform selection operations. A scroll wheel circuit 60 connects with the scroll wheel 11 (see FIG. 1A) for outputting scrolling signals that perform scroll operations on the computer, and a position calculator circuit 70 connect with the led 17 (see FIG. 1B) of the optical mouse for outputting cursor signals to control a cursor of the computer according to the movement of the wireless mouse 1. The select signals, the scroll signals, and the cursor signals are collectively referred to as the mouse operational signals hereinafter. The mouse operational signals are encoded by the encoder/decoder module 302 and transmitted to the computer via the wireless transceiver module 301, thereby controlling the operation of the computer.

The circuit board 3 further includes an audio processing module 40 for processing an analog audio signal. The audio processing module 40 includes an audio output unit 401, an audio input unit 402 and an audio amplifying circuit 403. The audio output unit 401 is used for outputting an audio signal received by the wireless module 30 from the computer. The audio signal is then transmitted to a speaker 15 or an earphone jack 13. The audio input unit 402 is an audio interface or an audio sensor such as a microphone 14 used for receiving an analog audio signal. The analog audio signal is processed by the audio processing module 40 before transmitted to the computer through the wireless module 30. The audio amplifying circuit 403 is used for amplifying the analog audio signals from the computer and the audio input unit 402.

The mouse 1 (see FIG. 1) is operable to produce the operational signals. The operational signals are transmitted to a microprocessor 20 that includes an A/D (analog-to-digital) converter 201 and a D/A (digital-to-analog) converter 202. The operational signals are converted into digital operational signals by the A/D converter 201. The digital operational signals are outputted to the wireless module 30. The encoder/decoder module 302 of the wireless module 30 encodes the digital operational signals and transmits the encoded operational signals wirelessly to the computer through the transceiver module 301.

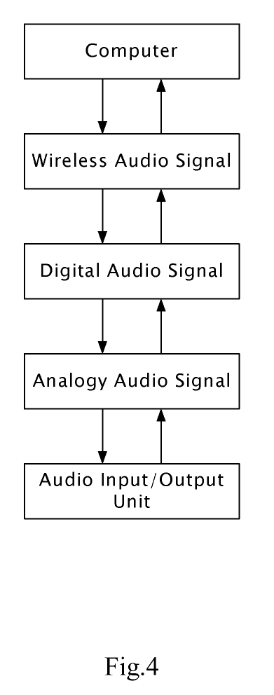

FIG. 4 shows a flow chart of an audio communication between the mouse and the computer. The mouse 1 can receive wireless audio signals from the computer through the wireless transceiver module 301. The wireless audio signals are outputted from the 301 to the encoder/decoder module 302 that decodes the wireless audio signals and accordingly outputs digital audio signals to the microprocessor 20. The digital audio signals are converted by the D/A converter 202 into analog audio signals which are outputted to the audio processing module 40. The analog audio signals are amplified by the audio amplifying module 403 of the audio processing module 40 before outputted to the audio output unit 401, and play the amplified analog audio signals by the speaker 15 or an earphone inserted into the earphone jack 13.

The mouse 1 can also receive analog audio signals through the audio input module 402 from an audio sensor such as a microphone 14 (see FIG. 1A), the analog audio signals are inputted to the audio amplifying module 403 for amplifying and amplified analog audio signals are outputted to the A/D converter 201. The A/D converter 201 converts the amplified analog audio signals to digital audio signals and outputs the digital audio signals to the wireless module 30. The encoder/decoder module 302 of the wireless module 30 encodes the digital audio signals and outputs wireless audio signals to the wireless transceiver module 301. The wireless transceiver module 301 transmits the wireless audio signals to the computer using a wireless transmission protocol.

The mouse 1 further includes a laser beam module 10. The laser beam module 10 connect with a laser led 16, the led laser 16 can emit a laser beam and be used as a pointer to assist in teaching, meeting, training, and giving speeches.

Although the present invention has been specifically described on the basis of a preferred embodiment and method thereof, the invention is not to be construed as being limited thereto. Various changes or modifications may be made to the embodiments without departing from the scope and spirit of the invention.

What is claimed is:

1. A multi-functional wireless mouse comprising:
a wireless module, comprising:
a wireless transceiver module; and
an encoder/decoder module;
a microprocessor comprising an A/D converter and a D/A converter;
an audio amplifying circuit; and
an audio output unit;
wherein, the wireless module receives wireless audio signals from a computer and outputs the wireless audio signals to the encoder/decoder module, the encoder/decoder module decodes the wireless audio signals and outputs digital audio signals to the microprocessor, the microprocessor converts the digital audio signals to analog audio signals and outputs the analog audio signals to the audio amplifying circuit, the audio amplifying module amplifies the analog audio signals and transmits the amplified analog audio signals to the audio output unit to output.

2. The mouse as claimed in claim 1, further comprising an audio input unit for receiving analog audio signals from an audio sensor.

3. The multi-functional wireless mouse as claimed in claim 2, wherein
the audio input module receives a audio signal then output it to the audio amplifying circuit to amplify and obtain a amplified analog audio signal, the A/D converter convert the amplified audio signal to a digital audio signal and output it to an encoder/decoder module, the encoder/decoder module encode the digital audio signal to a wireless audio signal, the wireless transceiver module receives the wireless audio signal and transmit it to a computer.

4. The mouse as claimed in claim 1, wherein the wireless transceiver module is a Bluetooth chip.

5. The mouse as claimed in claim 1, further comprising a laser beam module and a laser led for generating a laser beam.

6. The multi-functional wireless mouse as claimed in claim 1, wherein the audio output unit is connected to a speaker and outputs the analog audio signals to the speaker.

7. The multi-functional wireless mouse as claimed in claim 2, wherein the audio output unit is connected to an earphone and outputs the amplified analog audio signal to the earphone.
